(19) United States
(12) Patent Application Publication
(10) Pub. No.: US 2006/0292348 A1
(43) Pub. Date: Dec. 28, 2006

(54) Method of making a print carrier with an optically birefra

(75) Inventors: Peter Schmitt, Wurzburg (DE); Siegfried Schmitzer, Kurnach (DE)

Correspondence Address: THE FIRM OF KARL F ROSS, 5676 RIVERDALE AVENUE, PO BOX 900, RIVERDALE (BRONX), NY, 10471-0900, US

(73) Assignee: METRONIC AG

(21) Appl. No.: 11/512,128

(22) Filed: Aug. 29, 2006

Related U.S. Application Data
(62) Division of application No. 10/876,095, filed on Jun. 24, 2004.

(30) Foreign Application Priority Data
Jun. 25, 2003 (DE) 10328744-2

(51) Int. Cl. B32B 3/00

(52) U.S. Cl. 428/156

(57) ABSTRACT

The invention relates to a print carrier, in particular data or information carriers, which is provided at least in some areas with a transparent anisotropic layer, in particular an optically colorless birefractive layer, in particular which is arranged on a layer-oriented structure. Furthermore, the invention relates to a method for producing a print carrier with an optically anisotropic layer arranged at least in some areas on it, in which an anisotropic layer, in particular a birefractive nematogenous layer comprising liquid crystals, is applied by means of a printing process to at least one section of the print carrier which has at least one layer-oriented structure.

### CROSS REFERENCE TO RELATED APPLICATIONS

The instant application is a division of U.S. patent application Ser. No. 10/876,095 filed 24 Jun. 2004 with a claim to the priority of German patent application 103 28 744.2 filed 25 Jun. 2003.

### FIELD OF THE INVENTION

The invention relates to a print carrier, in particular tags, labels, information or data carriers, admission tickets, value cards, etc., and a method for producing a print carrier of this type.

### BACKGROUND OF THE INVENTION

It is known from the prior art to use print carriers e.g. for security and authentication of, for example, any wares desired, e.g. software products, money cards, etc. In this case, it is known, inter alia, to use embossed prints, also in the form of blind embossings or in association with embossed holograms which are difficult to forge.

The Laid-Open Specification DE 198 45552 A1 discloses a data carrier, e.g. securities, banknotes, identity cards or the like, which is provided with an embossing in a predetermined area. At least one part of the embossing has the form of an inclined plane. In addition, the embossed area of the data carrier is provided with at least one color layer or a sequence of color layers whose optical effect varies dependent on the viewing angle due to the inclined plane in order to thus make the embossing more visible to a viewer dependent on the viewing angle.

The print carriers known in the prior art all have the disadvantage that the security of a product is immediately discernible with the naked eye since the print carrier conspicuously stands out against the background or an embossing in the print carrier stands out conspicuously against the rest of the print carrier. Therefore, a forger is always aware of the fact that he must always also forge the specific print carrier to forge the product. Forgery of such print carriers can be accomplished professionally such that it is difficult to some degree both for the layman and the expert to distinguish forged products from original products.

### OBJECT OF THE INVENTION

The object of the invention is to create a print carrier and a method for producing said print carrier which, when viewed, does not show any distinguishable areas to the naked eye or a security print is not discernible when simply viewed, so that e.g. a product security with a print carrier of this type is inconspicuous. Due to the non-obvious recognizability of a product security with a print carrier of this type, forgery is made considerably more difficult for the forger and, at the same time, a forgery without the feature according to the invention can be immediately and easily recognized.

### SUMMARY OF THE INVENTION

According to the invention, this object is solved in that the print carrier is provided at least in some areas with a transparent, anisotropic layer, in particular an optically colorless birefractive layer which is, in particular, applied to a layer-oriented structure.

A print carrier of this type can be produced by means of a printing process by applying an anisotropic layer, in particular a birefractive layer of e.g. nematogenous liquid crystals, to at least a section of the print carrier which has at least one layer-oriented structure. Smectic and chirally nematic liquid crystals can also be used.

In contrast to the prior art, e.g. according to the Laid-Open Specification DE 198 45552 A1, it is just this fact that a print or an embossing can not be made to stand out with the process according to the invention and can not be recognized, or easily recognized, with the naked eye since the anisotropic layer is transparent, preferably colorless, and the optical effect is therefore essentially given by the print carrier which shines through the layer, i.e. due to its coloring or structural appearance.

There is no color effect dependent on the viewing angle, inclined planes which are complicated to produce can, but do not have to be present to establish a color effect dependent on the viewing angle. Rather, according to the invention, it is a print which also includes an embossing which can not be tangibly or visually distinguished in any way from a blind embossing or an embossing based on conventional, optically isotropic clear lacquers without, in particular, optical aids. In this manner, concealed information can be integrated or shown in the print which is produced by optically recognizable differences between an anisotropic layer and remaining areas or also by differences within the anisotropic layer.

The invention can be used e.g. when printing security documents, such as e.g. banknotes, securities, credit cards and identity cards. In this case, the print carrier itself can already be the product to be protected, as is the case for example in banknotes or credit cards, or the print carrier can be applied as an additional security feature or the print carrier can be affixed or fastened in the form of a so-called security date to any products desired.

The transparent anisotropic layer has e.g. optical polarization-dependent effects which e.g. can not be perceived with the eye, but can be detected with auxiliary means, e.g. with a birefractive property by linear or circular type polarization filters, in particular, are made visible to the eye of a viewer with such auxiliary means.

Especially preferred, liquid crystals can be used as an anisotropic layer having a birefractive property, e.g. nematic liquid crystals, or lacquers or the like which contain such liquid crystals and form such a liquid crystal film on a print carrier during printing or embossing. Liquid crystalline mixtures of this type which can be hardened by means of radiation are produced, for example, by the firm Merck KGaA. These mixtures are almost invisible on the print carrier after they have been applied, however, with the appropriate background, e.g. a reflective print carrier, and with aid of linear or circular polarizers exhibit clear visual optical effects.

A liquid crystal layer of this type can e.g. be applied to a preferably glossy, metal print carrier by means of embossing, the resultant, e.g. nematic films can then be optionally permanently fixed with appropriate methods, e.g. by radiation with UV light.

When viewing with the naked eye, these embossed prints do not in any way differ from corresponding blind embossings or those embossed prints which were applied using standard clear lacquers. Therefore, they exhibit conventional, three-dimensional optical effects produced by light and shadow effects, but do not allow the embossing to stand out in an optically strong fashion in any way, i.e. not by producing additional contrasts or color effects dependent on the viewing angle. A purely tangible distinction is also not possible.

The embossed prints which were produced using the nematogenous mixtures only appear in a more or less optically prominent manner, e.g. in a colorful glossy manner, when viewing through a linear or circular polarizer. In this case, the color effects can be additionally dependent to a large extent on the (angular) position of the polarizer.

The differences in appearance can be detected not only with the eye of a viewer, but also mechanically, e.g. by means of detectors for different polarization directions of the reflected light, so that it is also possible to examine a print carrier according to the invention automatically.

The reason for this behavior of the liquid crystal components is their spatial orientation which is, in turn, predetermined to a special extent by the forces acting during the embossing process, in particular shearing forces, and also on the respective fine structures of the print carriers or embossing tools.

Therefore, if one divides an embossed print into various (partial) sections which are spatially delineated from one another and if forces orientating in the individual sections which differ from one another in their directions are used when the embossed print is being produced or if individual, defined sections of the print carrier or of the stamping tools are structured in different directions respectively, then an embossed print results whose sections are distinguished by different optical effects when viewing through a polarizer.

The embossed prints according to the invention are especially suitable for appearing inconspicuous to the naked eye in the presence of blind embossings and embossings based on commercial clear lacquers. However, actually, they represent an optical information which can be made visible or detectable with aid e.g. of a polarizer. In this way, the invention can be used in security printing of e.g. securities, banknotes and credit cards or to increase security against forgery of corresponding documents.

Thus, preferably, a print carrier according to the invention will also comprise, in addition to at least one section with an anisotropic layer, at least one section with a blind embossing and/or an uncoated relief and/or at least one section with a commercial, optically isotropic clear lacquer. The printed or embossed structures according to the invention can be produced especially easily e.g. with a modified flexoprinting process. In this case, e.g. the rolling off of a hard cliché e.g. having a shore hardness D of about 60°-70° over the preferably reflective, permanently formable print carrier or print material, the inking cylinder being equipped with an elastic rubber cloth e.g. having a shore hardness A of e.g. about 50°-60°.

The depth of the embossings is controlled via the height of the contact pressure. In addition, areas of different embossing depths can be obtained e.g. by varying the cliché thicknesses in one and the same typography. Depending on whether and what printing substance is use for printing with the cliché, either blind embossings are produced, or embossings which are coated with e.g. isotropic clear lacquers or the optically birefractive e.g. nematic liquid crystal films which are especially important in this connection.

The latter is based e.g. on the corresponding nematogenous liquid crystal mixtures which can be obtained e.g. from the firm Merck KGaA and can be used e.g. in the form of its melts tempered to about 60-70° C. or in the form of its solutions in organic solvents.

In addition, the embossing according to the invention can be produced with any embossing tool desired. It can e.g. be designed in relief in intaglio printing, the embossed structures being etched into a metal plate according to known processes. An electronic process for producing intaglio printing plates is described, for example, in WO 97/48555. During the printing process, the printing substance is pressed into the recesses of the engraved metal plate and effectively formed in this way. To produce a blind embossing, these printing plates are not filled with printing substances during the printing process, but are only used to form, i.e. to emboss, the print material. Regardless of the question whether a recessed or raised embossing is produced from the process, it is impossible for the examiner to distinguish e.g. between a blind embossing, an embossing using commercial (optically isotropic) clear lacquers and an embossing using nematogenous liquid crystal mixtures with the naked eye. Rather, the viewer sees a uniform embossed structure which conveys the usual three-dimensional optical effects due to light and shadow effects.

However, they can have a fine structure which is quite difficult to forge due to repeated printing e.g. just by miniaturizing and crossing of the individual print areas, said fine structure is only revealed when viewed through a linear or circular polarizer in the form of different optical effects dependent on the viewing angle.

In a typical application in which e.g. a high-gloss, silver-colored, unstretched polyethylene foil was embossed as print carrier using a nematogenous, 60° C. hot liquid crystal melt, the viewer can only see the embossed areas in the color blue which is provided with a nematic liquid crystal film with aid of a linear polarizers in the position 0°. All other areas do not exhibit any difference in comparison to viewing without a polarizer. When turning the polarizer by 45°, the blue color effect becomes yellowish-red.

The color effects are similar when analyzing the embossed print with a circular polarizer. In this case, the color effects change according to the position of the polarizer, e.g. between a glossy gold and a glossy silver-blue. However, cases in which the colors do not undergo any significant change at every 45° but, in particular, at every 90°, dependent on the position of the polarizer are also possible or there are cases in which there is only a slight change in color between e.g. a darker and a lighter brown.

Generally, this (dynamic) color behavior depends on a number of factors which include, for example, the print carrier properties, the printing process used, the flow and moistening properties of the liquid crystal ink as well as the thickness, homogeneity and fine structure of the liquid crystal film produced.

Generally, the e.g. nematic films appear clearly stronger reflective when viewed through a circular polarizer than when using a linear polarizer. Varying the viewing angle does not in any case have an effect on the respectively won color effect.

A special embodiment of the method is when e.g. the aforementioned modified flexoprinting process or similar process is used which are accompanied by the exertion of a force, e.g. a shearing force, on the (nematogenous) liquid crystal films during the embossing process and the embossing tools of which are structured such that a microscopic orientation of the components of the resultant liquid crystal film is aided in a preferential direction.

If, for example, the typography is rotated about an angle, preferably by 45°, using nematogenous liquid crystal mixtures after a first embossing process and if this is followed by a second embossing process, then a two-color embossed print is revealed to the viewer when analyzing with a linear or circular polarizer. Multicolored embossings are possible by using the entire span between the possible color effects.

The surface pressures and thus the embossing depth can be made as small as desired so that, although embossed structures can no longer be seen with the naked eye, it nevertheless produces an orientation of the liquid crystals, as a result of which at least corresponding color effects occur when using a polarizer.

It is essential for all procedural embodiments according to the invention that an anisotropic layer, in particular birefractive layer of e.g. nematogenous liquid crystals, are applied by means of any printing process desired to at least a section of a print carrier which has at least one layer-oriented structure.

As a result of the structure, a force can act in at least one direction on the liquid crystals of an anisotropic liquid crystal layer which produces an alignment of the liquid crystals, in particular along the respectively acting force.

One or more such structures can be applied to an area of the print carrier to be printed before or during the printing of the anisotropic layer. Therefore, print carriers which are used here can already be delivered with this type of a structure or they can be provided with said structure in the printing machine, e.g. during application of the printing substance.

Origin and type of structure are essentially irrelevant if they have the property to produce a layer orientation of the anisotropic layer, i.e. e.g. a crystal orientation of the liquid crystals. A print carrier can thus be provided with a mechanical structure and/or an electrostatic structure or load distribution. Separate orientation layers can also be applied before the liquid crystal layer. Changes or specific alignments of the crystal orientation can also be produced by local heating of the applied liquid crystal layer or by local application of electric and/or magnetic fields.

Further embodiments of the method e.g. of the print carrier according to the invention relate, for example, to:
producing positive and negative embossings in one and the same typography,
finishing optically anisotropic or varicolored print carriers with the process according to the invention,
using print carriers which have not been pre-embossed having preset and locally defined, various orientation directions for mesogenous systems,
printing or coating pre-embossed print carriers, also with holographic structures or otherwise, e.g. reliefs produced by methods of injection molding and other shaping techniques with e.g. nematogenous liquid crystal mixtures, in particular, whereby the structurings of the embossed areas or reliefs can aid the orientation of the textures of the optically anisotropic liquid crystal films,
producing optically anisotropic liquid crystal films of various thicknesses in one and the same embossed print, as a result of which further color effects are produced,
applying an additional transparent, optically isotropic or anisotropic surface lacquer layer, foil or the like for the purpose of e.g. guarding against scratching or increasing security of the embossing against forgery,
subsequent embossing of partially or completely hardened, optically anisotropic, e.g. nematic liquid crystal films,
embossed print on transparent print carriers and the defined printing on the reverse side of these print carriers thus treated with e.g. reflective colors.
In the first step, printing or coating a carrier film with a preferably completely hardened, nematic liquid crystal film in which the procedural parameters are set such that there is only a defined slight, yet sufficient cohesion between carrier foil and liquid crystal film. In the second step, transferring defined sections of the liquid crystal film to a print carrier by processing the reverse side of the appropriately printed or coated carrier foil with appropriate embossing tools, said process can be carried out both at room temperature or lower or higher temperatures and also under the action of only very weak embossing forces. According to the method, a print carrier which can be shaped is preferred which has an increased adhesive force compared to the carrier foil and which is capable of reflecting the light so that the optical effects of the invention become visible with aid of a polarizer.

### BRIEF DESCRIPTION OF THE DRAWING

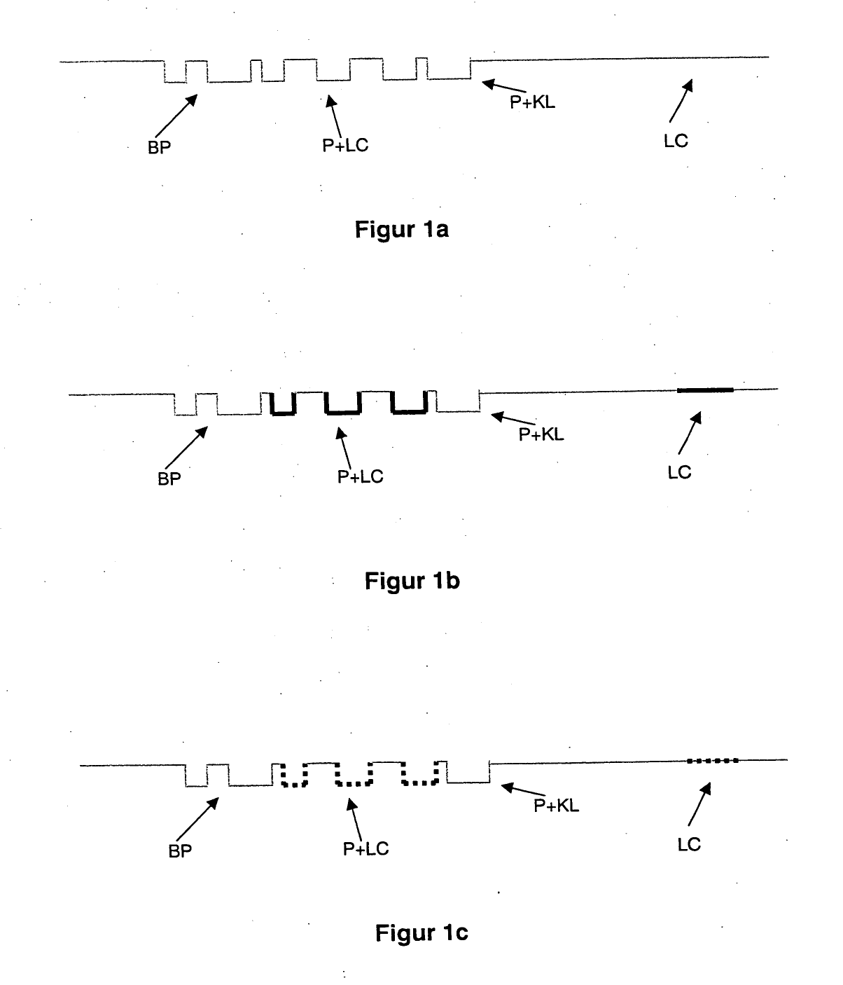

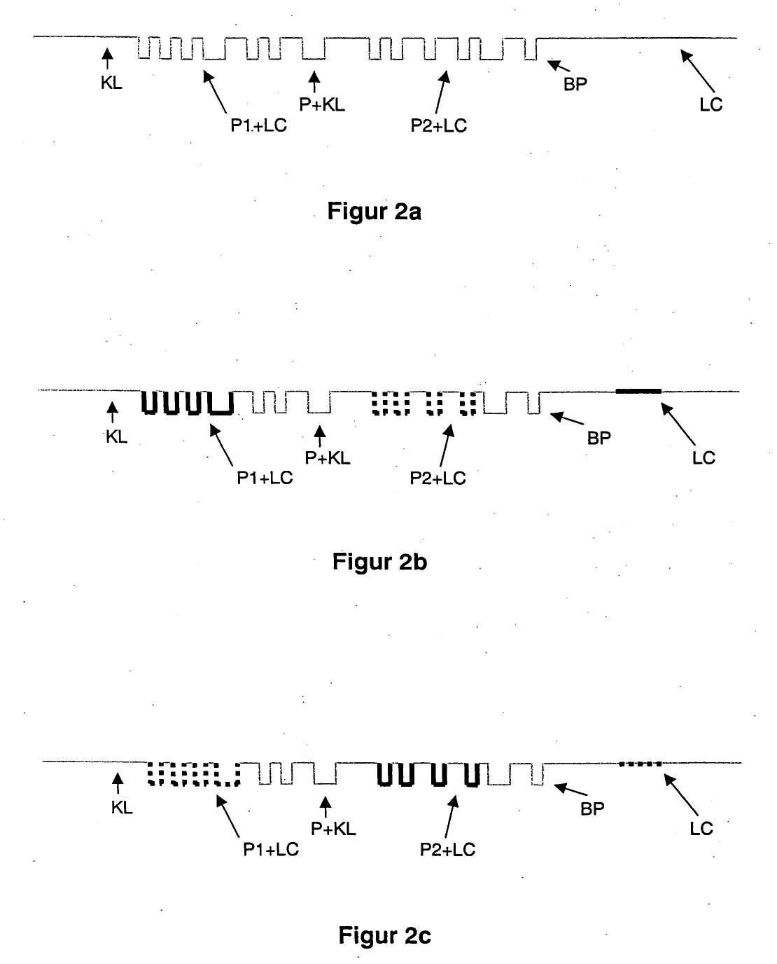

Examples of embodiments and advantages of the invention will be described with reference to FIGS. 1a, 1b, 1c and 2a, 2b, 2c. These figures are not true to scale, only show the color effects schematically and only serve to illustrate the invention.

### SPECIFIC DESCRIPTION

FIG. 1a shows a schematic representation of an embossing according to the invention on a silver-colored, glossy print carrier and the perceived color effect (shown in a simplified manner) without optical aids. Essentially, only the embossed structure can be recognized, however, no difference in color between the areas BP of the blind embossing without any lacquer layer whatsoever, P+LC of the embossing with liquid crystal layer, P+KL of the embossing with isotropic clear lacquer and the area LC, not embossed, which has only one liquid crystal layer.

FIG. 1b shows the same embossing according to the invention of FIG. 1a on a silver-colored, glossy print carrier and the perceived, exemplary color effect (shown in a simplified manner) when viewed through a linear polarizer in the position 0°. Due to the crystal orientation, both the embossed area P+LC and the non-embossed area LC now appear highlighted in color. This area is shown by a bold line.

FIG. 1c shows the same embossing 1a according to the invention on a silver-colored, glossy print carrier and the perceived color effect (shown in a simplified manner) when viewed through a linear polarizer, now in the position 45°. In this case, the areas P+LC and the area LC now have another color effect than in FIG. 1b due to the changed position of the polarizer. This other color effect is indicated by the bold dotted lines.

FIG. 2a shows an embossing according to the invention on a silver-colored, glossy print carrier and the perceived color effect (shown in a simplified manner) without optical aids. Again, it can be seen here that, without polarizing aids, the color effect for the area KL (isotropic clear lacquer without embossing), P1/P2+LC (embossings ½ with liquid crystal), P+KL (embossing with isotropic clear lacquer), BP (blind embossing without lacquer) and LC (liquid crystal without embossing) is the same everywhere.

FIG. 2b shows the embossing 2a according to the invention on a silver-colored, glossy print carrier and the perceived exemplary color effect (shown in a simplified manner) when viewed through a linear polarizer in the position 0°. The areas KL and P+KL do not show any change of the color effect since only isotropic clear lacquer is applied in this case. On the other hand, the areas P1+LC and P2+LC now have two different color effects since the embossings in these areas are such that different orientations of the liquid crystals have set in. The color effect of the area LC can correspond to the area P1+LC.

FIG. 2c shows the embossing 2a according to the invention on a silver-colored, glossy print carrier and the perceived color effect (shown in a simplified manner) when viewed through a linear polarizer, now in the position 45°. Again, different color effects are produced in the areas P1+LC, P2+LC and LC coated with the liquid crystals. In this case, the color effect is exactly the reverse of that in FIG. 2b due to the changed position of the polarizer.

1. A method for producing a print carrier with an anisotropic layer arranged at least in some areas on it, in particular according to claim 1, characterized in that an anisotropic layer, in particular a birefractive nematogenous layer comprising liquid crystals, is applied by means of a printing process to at least one section of the print carrier which has at least one layer-oriented structure.

2. The method according to claim 1, characterized in that, due to the structure, a force acts in at least one direction on the liquid crystals of an anisotropic liquid crystal layer which produces an alignment of the liquid crystals, in particular along the respectively acting force, in particular prior to hardening of the layer.

3. The method according to claim 1, characterized in that, prior to or during the printing of the anisotropic layer, the area to be printed is provided with a mechanical structure and/or electrostatic structure or load distribution, in particular wherein said structure produces one or more different orientations of the anisotropic layer.

4. The method according to claim 1, characterized in that the structure is produced by printing and/or embossing tools prior and/or during the printing process or by injection molding or shaping techniques, in particular wherein the shaping tools have a corresponding structure.

5. The method according to claim 1, characterized in that the layer-oriented structure is produced by a printing cylinder.

6. The method according to claim 1, characterized in that, after a printing process, the print carrier is turned by an angle and that at least one further printing process takes place subsequently.
